(19) United States
(12) Patent Application Publication
(10) Pub. No.: US 2026/0225717 A1
(43) Pub. Date: Aug. 6, 2026

(54) ON-BOARD COMPUTING SYSTEM FOR AN AIRCRAFT, METHOD FOR PROVIDING COMPUTING POWER IN AN AIRCRAFT, AND AIRCRAFT

(71) Applicant: Airbus Operations GmbH, HAMBURG (DE)

(72) Inventors: Kai MÖLLER, HAMBURG (DE); Jörn-Oliver KRUMSIEG, HAMBURG (DE)

(21) Appl. No.: 19/463,281

(22) Filed: Jan. 29, 2026

(30) Foreign Application Priority Data
Jan. 31, 2025 (DE) 10 2025 000 400.1

(51) Int. Cl. B64D 11/00; G06F 1/26

(52) U.S. Cl. CPC B64D 11/0015; G06F 1/26

(57) ABSTRACT

An on-board computing system for an aircraft. The computing system has a cabin backbone system with system-owned resources configured to provide first computing power. The computing system further includes at least one device interface configured to connect to at least one passenger-owned device which has device-owned resources configured to provide a second computing power to the cabin backbone system. The cabin backbone system is configured to control utilization of the second computing power provided via the device interface to form a resource pool controlled by the cabin backbone system to enhance the first computing power of the cabin backbone system.

### CROSS-REFERENCES TO RELATED APPLICATIONS

This application claims the benefit of German Patent Application Number 10 2025 000 400.1 filed on Jan. 31, 2025, the entire disclosure of which is incorporated herein by way of reference.

### FIELD OF THE INVENTION

The present invention relates to providing additional computing power in an aircraft. In particular, the present invention relates to an on-board computing system. Further, the present invention relates to a method for providing computing power in an on-board computing system for an aircraft. In addition, the present invention relates to an aircraft comprising and/or utilizing such computing system and/or method.

### BACKGROUND OF THE INVENTION

In an aircraft, hardware resources are a significant limiting factor, as these cannot be carried by the aircraft in any extent, among other things due to limitations in space, weight, cooling, etc. Beyond these limitations due to the aircraft's design and physics, these resources have to be shared between several different cabin systems, with only a slice of the hardware resources being made available for each system. And this resource slice is then possibly further subdivided between several different functions within the relevant cabin system. Thus, only limited hardware resources are available on an aircraft.

For example, DE 10 2017 117 061 A1 describes the utilization of portable electronic devices (PEDs) in a peer-to-peer network (P2P network) of an airplane, where the PEDs are operated with the BitTorrent protocol to receive individual pieces of media content and to function as a so-called “seed” to share or redistribute the received individual pieces of the media content. Thereby, the “seeds” have the option to throttle or reduce output based on the resources used by the “seeds”.

In view of the above, it would be desirable to have more hardware resources and/or more computing power available in an aircraft.

### SUMMARY OF THE INVENTION

An object of the invention is to provide at least one of more hardware resources and more computing power to an aircraft. This object may be solved by the subject-matter of one or more embodiments described herein.

According to a first aspect, there is provided an on-board computing system for an aircraft. The computing system comprises a cabin backbone system. The cabin backbone system comprises system-owned resources configured to provide first computing power. Further, the computing system comprises at least one device interface configured to connect at least one passenger-owned device (POD) to the cabin backbone system. The at least one passenger-owned device comprises device-owned resources configured to provide second computing power. The cabin backbone system is configured to control utilization of the second computing power provided via the at least one device interface to form a resource pool controlled by the cabin backbone system to enhance the first computing power of the cabin backbone system.

The proposed computing system allows for providing additional computing power of the at least one passenger-owned device, i.e., the second computing power, to the central cabin backbone system. Regardless of the device type of the at least one passenger-owned device, such devices may have powerful hardware resources that may provide a correspondingly large amount of second computing power. The additional computing power, i.e., the second computing power, can be utilized for a wide range of use cases that enhance and/or expand the cabin operations, e.g., for the cabin crew. This can directly or indirectly enhance the flight experience of the passengers. Merely by way of example, the additional computing power may be used to enable artificial intelligence applications or functions in the aircraft, especially in the cabin backbone system. In addition, this may enable other computing-intensive applications within an aircraft.

As used herein, the cabin backbone system may be understood as a central digital data and/or a central computing system configured to allow cabin crew to manage one or more cabin functions. For example, it may comprise at least one computer, e.g., central computer, or the like. Alternatively or additionally, the cabin backbone system may comprise or may be a server. The cabin backbone system may comprise processing circuitry. The processing circuitry may comprise at least one of a CPU, or another general-purpose processor, a digital signal processor (digital signal processor, DSP), a graphics processing unit (GPU), an ASIC, an FPGA or another programmable logic device, a discrete gate or transistor logic device, a discrete hardware component, or the like. The general-purpose processor may be a microprocessor, any conventional processor, or the like. The cabin backbone system may comprise one or computing means such as at least one processor, at least one memory, at least one network interface, e.g., wired and/or wireless, a data network, a bus system, and a communication interface. By way of example, the cabin backbone system may be configured to manage at least one of cabin light, emergency light, door bottle pressure monitoring, door closure status, slide armed/disarmed status, water and waste tank quantities, air conditioning, and smoke detection. Further, the cabin backbone system may be configured to manage passenger entertainment. At least some of the aforementioned functions managed by the cabin backbone system may be mandatory and may be carried out with only the first computing power, i.e., by the system-owned resources. For example, for controlling the utilization of the additional, second computing power, the cabin backbone system may comprise at least one controller.

For example, the cabin backbone system may be configured for distributed computing, wherein the cabin backbone system itself and the at least one passenger-owned device form a distributed computing system. For example, the cabin backbone system may be configured to communicate and coordinate computing actions, tasks, or the like, e.g., by passing messages to and receiving messages from the at least one passenger-owned device. Such messages may be communicated via the at least one device interface, and a corresponding data interface of the at least one passenger-owned device. Further, by way of example, the cabin backbone system may be configured to use the distributed computing system to solve computational problems, tasks, or the like. Thereby, a computational problem may be divided into one or more tasks, each of which is solved by the computing means of the distributed computing system, i.e., at least in part by the at least one passenger-owned device. The cabin backbone system may be configured to determine at least one task to be computed by utilizing the second computing power. Multiple tasks may be queued, e.g., in a thread pool or the like. Thereby, the second computing power may be utilized by providing the at least one task to the at least one passenger-owned device for computing. After having computed the at least one task, the at least one passenger-owned device may provide the corresponding computation result to the cabin backbone system, thereby providing the second computing power. The at least one task may comprise an indication of a priority for computation. That is, the at least one task may be prioritized, for example, depending on the number of passenger-owned devices connected to the cabin backbone system.

Further, as used herein, the at least one device interface may be understood as any suitable device interface configured to allow at least one device to be connected to the at least one device interface, e.g., wired and/or wirelessly. The at least one device interface is operatively connected to the cabin backbone system. The connection between the at least one device interface and the at least one passenger-owned device may be selective and/or detachable. For example, the at least one device interface may be at least one of or may utilize a USB interface, Firewire interface, WLAN, Bluetooth®, or a comparable future interface, wherein this is not limited herein.

As used herein, the at least one passenger-owned device may be any electronic device or computer device carried by a passenger. It is not actually part of the aircraft's equipment. Accordingly, the at least one passenger-owned device changes regularly, e.g., each flight and/or with changing the respective passenger. It may be a portable device. Examples of the at least one passenger-owned device comprise smartphones, tablets, laptops, wearable devices, such as smartwatches, etc. Correspondingly, the at least one passenger-owned device comprises at least one interface configured to be connected to the at least one device interface of the computing system of the aircraft. For example, the at least one interface of the passenger-owned device may be at least one of a USB interface, Firewire interface, WLAN, Bluetooth®, or a comparable future interface, wherein this is not limited herein.

The device-owned resource may comprise at least one processing circuitry. The processing circuitry may comprise at least one of a CPU, or another general-purpose processor, a digital signal processor (DSP), an ASIC, an FPGA or another programmable logic device, a discrete gate or transistor logic device, a discrete hardware component, or the like. The general-purpose processor may be a microprocessor, any conventional processor, or the like. Alternatively, the processor may be a graphics processing unit (GPU), a microprocessor, an ASIC, or one or more integrated circuits. Further, the device-owned resource may comprise at least one memory, such as a RAM, etc. At least part of each of those device-owned resources may be utilized by the cabin backbone system. The at least one passenger-owned device may provide its second computing power via its interface and the corresponding device interface of the on-board computing system. The at least one passenger-owned device may share only part or all of its second computing power with the cabin backbone system. The respective amount of shared resources and/or computing power may be specified on the passenger-owned device's side, e.g., by the respective device's owner.

According to an embodiment, the cabin backbone system may be configured to combine the first computing power and the second computing power to provide at least one service and/or function in addition to a basic service and/or a basic function that can be provided with only the first computing power. For example, the at least one basic service and/or basic function may be at least one of the above-mentioned management of cabin light, emergency light, door bottle pressure monitoring, door closure status, slide armed/disarmed status, water and waste tank quantities, air conditioning, smoke detection, and passenger entertainment, etc. Such basic service and/or basic function may also be referred to as a mandatory service and/or function that is to be provided by utilizing only the system-owned resources and/or first computing power. The at least one additional service and/or function can be any service and/or function that is not mandatory but rather an enhancement. This is due to the fact that the number and/or type of the at least one passenger-owned device, and also the amount of device-owned resources provided, may change and/or fluctuate during operation of the aircraft and/or during the respective flight, since the respective passenger-owned device may be connected and disconnected at an unforeseen point of time. In this way, the resource pool allows for providing enhanced services and/or functions that could not be carried out with the first computing power alone.

For example, utilizing the resource pool comprising the first computing power and the second computing power may be used to enable high-quality games in an in-flight entertainment (IFE) that can only be provided with the additional second computing power. Such game may offer cooperation and/or competition between all passengers playing it during the flight. Also, it may offer advantages, such as scoring bonus miles, winning gift cards, or the like. Another example may be a detailed 3D guided tour of the flight destination that can only be provided with the additional second computing power. Of course, there are other computing-intensive services and/or functions conceivable that may only be carried out with the help of the additional second computing power.

In an embodiment, the resource pool comprising the first computing power and the second computing power may be utilized by the cabin backbone system to operate at least one artificial intelligence (AI)-based application configured to analyze cabin data received from at least one detection device capturing at least part of the cabin of the aircraft. For example, the AI-based application may be or may function as a cabin crew “companion” that gets more advanced and powerful the more device-owned resources and/or second computing power it has access to.

According to an embodiment the at least one artificial intelligence-based application may be configured to analyze, based on the received cabin data, at least one of a passenger-related issue and an equipment-related issue, and to report the at least one issue based on the analysis. For example, the at least one artificial intelligence-based application may be configured to analyze the available cabin data during operation of the aircraft and/or during flight, e.g., from a cabin video monitoring system (CVMS) video feed and/or at least one other cabin sensor. It may report and/or give notification about detected passenger-related issues, problems, such as illness, misbehavior, or the like, and report them accordingly. It may also detect technical errors and defects and report them accordingly. This may be done without or only with minimal cabin crew involvement, giving them more time to e.g. care for the passengers.

In an embodiment, the cabin backbone system may be configured to access the respective device-owned resources via an encapsulated application program at least partially run on the at least one passenger-owned device, the application program being configured to restrict data access from the respective passenger-owned device to the cabin backbone system and from the cabin backbone system to the respective passenger-owned device. For example, the encapsulation of the application program may comprise data encapsulation. This may comprise wrapping of data of the cabin backbone system and/or the of the passenger-owned device. Further, this may comprise application wrapping. Also, this may comprise wrapping of network data. Functionally, the encapsulation may refer to restricting access, especially direct access, to some or all data. From the cabin backbone system's perspective, restricting access to its data for the at least one passenger device ensures that e.g., attacks on the cabin backbone system can be prevented. From the at least one passenger-owned device's perspective, restricting access to its data for the cabin backbone system ensures e.g., user data privacy. For example, the at least one passenger-owned device may be configured to provide application wrapping for the application program, allowing the cabin backbone system to access only authorized resources, and preventing access to data, especially personal data. The application program may use so-called sandboxing, or another suitable mechanism allowing restricting access to data of the cabin backbone system and/or the at least one passenger-owned device. Alternatively or additionally, the cabin backbone system and the at least one passenger-owned device may communicate with each other using end-to-end-encryption. In this way, data protection can be provided at both sides, the cabin backbone system and the at least one passenger-owned device.

According to an embodiment, the cabin backbone system may be configured to receive authorization information from the at least one passenger-owned device. The authorization information indicates whether the respective passenger-owned device allows its second computing power to be used. In other words, the computing system may be configured to access only those connected passenger-owned devices that have authorized, e.g. via the above-mentioned application program, access to its resources. For example, the respective passenger-owned device may have run and/or installed the above-mentioned application program, and the passenger may actively authorize the utilization of the device's resources via the application program. In this way, the passenger can restrict and authorize access to the respective device-owned resources.

In an embodiment, the cabin backbone system may be configured to provide a prompt to the at least one passenger-owned device. The prompt may be configured to receive indication of a respective amount of the device-owned resources and/or of the second computing power to be made available to the resource pool. For example, the prompt may be generated by the above-mentioned application program. Merely by way of example, the prompt may comprise a slider or the like, configured to allow defining how many and/or which amount of the device-owned resources may be made available for sharing with the cabin backbone system. The amount of the device-owned resources shared may be indicated in percentage, e.g., between 0 and 100%. In this way, the respective passenger can decide whether and how many of the device-owned resources are to be shared.

According to an embodiment, the cabin backbone system may be configured to offer at least one incentive to the at least one passenger-owned device for providing its device-owned resources. Examples of the at least one incentive may include offering free charging of the at least one passenger-owned device, bonus miles, or any other incentive in exchange for getting access to the device-owned resource, i.e., the respective second computing power. This may also be offered, for example, if the respective passenger is not interested in access to e.g., enhanced IFE functions, or the like.

A second aspect provides an aircraft comprising an on-board computing system according to the first aspect. For possible embodiments and advantages reference is made to the first aspect. Due to the utilization of the at least one passenger-owned device, i.e., its device-owned resources, the aircraft can provide enhanced computing power without carrying additional fixed hardware resources.

In an embodiment, the aircraft may comprise at least one detection device configured to capture at least part of a cabin of the aircraft. For example, the at least one detection device may comprise at least one of a cabin video monitoring system (CVMS) video feed and at least one other cabin sensor.

According to a third aspect, there is provided a method for providing computing power in an on-board computing system for an aircraft. The method may be carried out by the computing system of the first aspect. Further, the method may be carried out on board of the aircraft according to the second aspect.

The method comprises providing, by a cabin backbone system comprising system-owned resources, first computing power. The method further comprises connecting, via at least one device interface, at least one passenger-owned device, comprising device-owned resources configured to provide second computing power, to the cabin backbone system. Further, the method comprises controlling, by the cabin backbone system, utilization of the second computing power provided via the at least one device interface to form a resource pool controlled by the cabin backbone system to enhance the first computing power of the cabin backbone system.

For possible embodiments and advantages reference is made to the first aspect. The proposed method allows for providing additional computing power of the at least one passenger-owned device, i.e., the second computing power, to the central cabin backbone system. Due to the utilization of the at least one passenger-owned device, i.e., its device-owned resources, an aircraft carrying out the proposed method can provide enhanced computing power without carrying additional fixed hardware resources.

A further aspect provides a computer program comprising instructions which, when executed by a computer, e.g., the cabin backbone system disclosed herein, cause the computer, e.g., the cabin backbone system, to utilize second computing power provided by at least one passenger-owned device. Alternatively or additionally, the computer program and/or its instructions may cause the computer to carry out the method according to the third aspect.

Another aspect provides a computer-readable medium comprising instructions which, when executed by a computer, e.g., the cabin backbone system disclosed herein, cause the computer, e.g., the cabin backbone system, to utilize second computing power provided by at least one passenger-owned device. Alternatively or additionally, the computer-readable medium and/or its instructions may cause the computer to carry out the method according to the third aspect.

The above-described aspects, embodiments, variants and examples can of course be combined without this being explicitly described. Each of the described variants and each example are thus to be regarded as optional for each of the aspects, embodiments, variants and examples or even combinations thereof. The present disclosure is thus not limited to the individual embodiments and variants in the described order or a certain combination of the aspects and variants.

### BRIEF DESCRIPTION OF THE DRAWINGS

The present invention is explained in more detail below with reference to the figures in the drawings. In the drawings:

FIG. 1 illustrates an exemplary on-board computing system for an aircraft according to an embodiment.

FIG. 2 illustrates an exemplary passenger-owned device to be utilized according to an embodiment.

FIG. 3 illustrates an exemplary aircraft according to an embodiment.

FIG. 4 illustrates in a flow chart an exemplary method for providing computing power in an on-board computing system for an aircraft, according to an embodiment.

In the figures of the drawing, elements, features and components which are identical, functionally identical and of identical action are denoted in each case by the same reference designations unless stated otherwise.

### DETAILED DESCRIPTION OF THE PREFERRED EMBODIMENTS

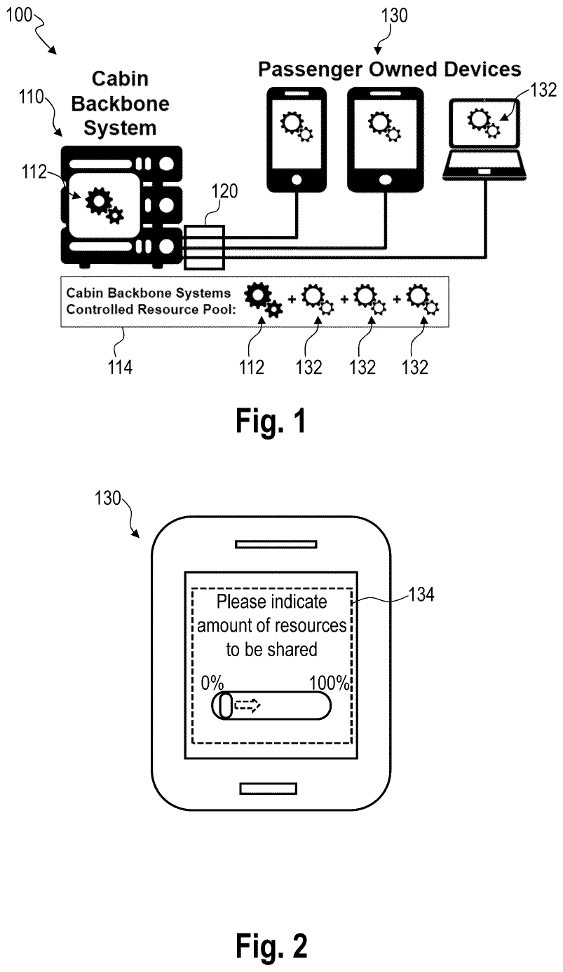

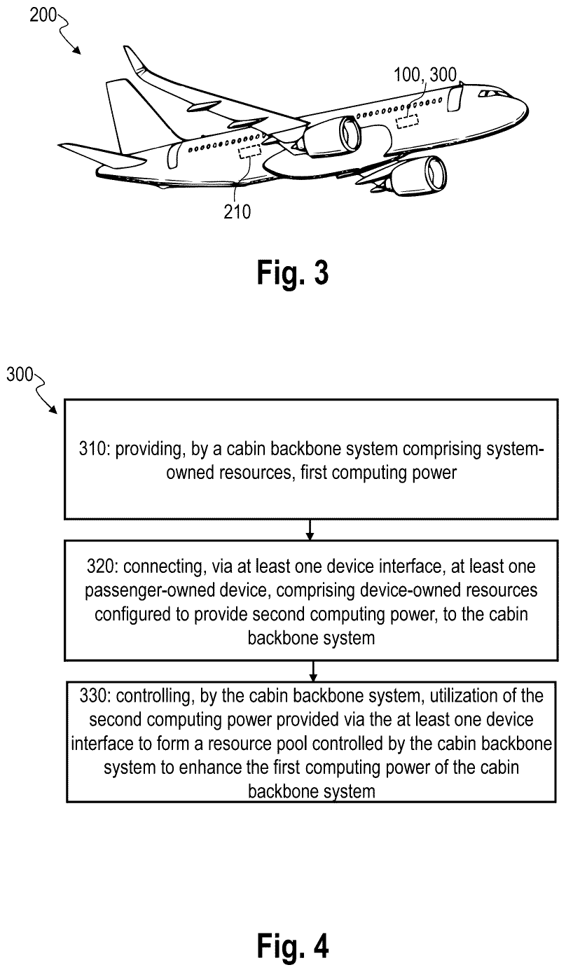

FIG. 1 illustrates an exemplary on-board computing system 100 for an aircraft (see e.g. aircraft 200 illustrated in FIG. 3). The computing system 100 comprises a cabin backbone system 110. The cabin backbone system 110 comprises system-owned resources 112, e.g., hardware and/or software resources, configured for computing. The system-owned resources 112 are configured to provide first computing power.

Further, the computing system 100 comprises at least one device interface 120. The at least one device interface 120 is configured to connect at least one passenger-owned device 130 to the cabin backbone system 110. The at least one passenger-owned device 130 comprises device-owned resources 132, e.g., hardware and/or software resources, configured for computing. The device-owned resources 132 are configured to provide second computing power.

The cabin backbone system 110 is configured to control utilization of the second computing power, provided via the at least one device interface 120, to form a resource pool 114. The resource pool 114 is controlled by the cabin backbone system 110 to enhance the first computing power of the cabin backbone system 110.

It is noted that although FIG. 1 exemplary illustrates three passenger-owned devices 130, only one single passenger-owned device 130 may be connected or a plurality of passenger-owned devices 130 may be connected via the at least one device interface 120, e.g., dozens or even hundreds of passenger-owned devices 130. The more passenger-owned devices 130 are connected the more computing power may be available to the resource pool 114. Further, it is noted that although in FIG. 1, device-owned resources 132 of only one passenger-owned device 130 are denoted, the gearwheels of the remaining two passenger-owned devices 130 also indicate corresponding device-owned resources 132, as denoted for the resource pool 114. This omission of reference signs is done for the sake of a clearer overview in FIG. 1.

For example, the cabin backbone system 110 may be configured for distributed computing, wherein the cabin backbone system 110 itself and the at least one passenger-owned device 130 form at least part of a distributed computing system. By way of example, the cabin backbone system 110 may be configured to communicate and coordinate computing actions, tasks, or the like, e.g., by passing messages to and receiving messages from the at least one passenger-owned device 130. Such messages may be communicated via the at least one device interface 120, and a corresponding data and/or device interface of the at least one passenger-owned device 130. Further, by way of example, the cabin backbone system 110 may be configured to use the distributed computing system to solve computational problems, tasks, or the like. Thereby, a computational problem may be divided into one or more tasks, each of which is solved by the computing means of the distributed computing system, i.e., at least in part by the at least one passenger-owned device 130. The cabin backbone system 110 may be configured to determine at least one task to be computed by utilizing the second computing power. Multiple tasks may be queued, e.g., in a thread pool or the like. Thereby, the second computing power may be utilized by providing the at least one task to the at least one passenger-owned device 130 for computing. After having computed the at least one task, the at least one passenger-owned device may provide the corresponding computation result back to the cabin backbone system 110, thereby providing the second computing power. The at least one task may comprise an indication of a priority for computation. That is, the at least one task may be prioritized, for example, depending on the number of passenger-owned devices 130 connected to the cabin backbone system 110.

The cabin backbone system 110 may be a central digital data and/or a central computing system configured to allow cabin crew to manage one or more cabin functions. For example, it may comprise at least one computer, e.g., central computer, or the like. Alternatively or additionally, the cabin backbone system 110 may comprise or may be a server. The cabin backbone system 110 may comprise processing circuitry. The processing circuitry may comprise at least one of a CPU, or another general-purpose processor, a digital signal processor (digital signal processor, DSP), a graphics processing unit (GPU), an ASIC, an FPGA or another programmable logic device, a discrete gate or transistor logic device, a discrete hardware component, or the like. The general-purpose processor may be a microprocessor, any conventional processor, or the like. The cabin backbone system 110 may comprise one or computing means such as at least one processor, at least one memory, at least one network interface, e.g., wired and/or wireless, a data network, a bus system, and a communication interface. By way of example, the cabin backbone system 110 may be configured to manage at least one of cabin light, emergency light, door bottle pressure monitoring, door closure status, slide armed/disarmed status, water and waste tank quantities, air conditioning, and smoke detection. Further, the cabin backbone system may be configured to manage passenger entertainment. At least some of the aforementioned functions managed by the cabin backbone system 110 may be mandatory and may be carried out with only the first computing power, i.e., by the system-owned resources 112. For example, for controlling the utilization of the additional, second computing power, the cabin backbone system may comprise at least one controller.

Further, by way of example, the at least one device interface 120 may be any suitable device and/or data interface configured to allow at least one device to be connected to the at least one device interface, e.g., wired and/or wirelessly. The at least one device interface 120 is operatively connected to the cabin backbone system 110. The connection between the at least one device interface 120 and the at least one passenger-owned device 130 may be selective and/or detachable. For example, the at least one device interface 120 may be at least one of or may utilize a USB interface, Firewire interface, WLAN, Bluetooth®, or a comparable, also future, interface, wherein this is not limited herein.

Moreover, by way of example, the at least one passenger-owned device 130 may be any electronic device or computer device carried by a passenger. It is not actually part of the aircraft's equipment. Accordingly, the at least one passenger-owned device 130 changes regularly, e.g., each flight and/or with changing the respective passenger. It may be a portable device. Examples of the at least one passenger-owned device 130 comprise smartphones, tablets, laptops, wearable devices, such as smartwatches, etc. Correspondingly, the at least one passenger-owned device comprises at least one interface configured to be connected to the at least one device interface 120 of the computing system 100 of the aircraft. For example, the at least one interface of the at least one passenger-owned device 130 may be at least one of a USB interface, Firewire interface, WLAN, Bluetooth®, or a comparable, also future, interface, wherein this is not limited herein.

The device-owned resources 132 may comprise at least one processing circuitry. The processing circuitry may comprise at least one of a CPU, or another general-purpose processor, a digital signal processor (DSP), an ASIC, an FPGA or another programmable logic device, a discrete gate or transistor logic device, a discrete hardware component, or the like. The general-purpose processor may be a microprocessor, any conventional processor, or the like. Alternatively, the processor may be a graphics processing unit (GPU), a microprocessor, an ASIC, or one or more integrated circuits. Further, the device-owned resource may comprise at least one memory, such as a RAM, etc. At least part of each of those device-owned resources may be utilized by the cabin backbone system. The at least one passenger-owned device may provide its second computing power via its interface and the corresponding device interface of the on-board computing system. The at least one passenger-owned device may share only part or all of its second computing power with the cabin backbone system. The respective amount of shared resources and/or computing power may be specified on the passenger-owned device's side, e.g., by the respective device's owner.

In at least some embodiments, the cabin backbone system 110 may be configured to combine the first computing power and the second computing power to provide at least one service and/or function in addition to a basic service and/or a basic function that can be provided with only the first computing power.

Further, in at least some embodiments, the resource pool 114 comprising the first computing power and the second computing power may be utilized by the cabin backbone system 110 to operate at least one artificial intelligence-based application configured to analyze cabin data received from at least one detection device capturing at least part of a cabin of the aircraft. For example, the at least one artificial intelligence-based application may be configured to analyze, based on the received cabin data, at least one of a passenger-related issue and an equipment-related issue, and to report the at least one issue based on the analysis. Alternatively or additionally, the respective issue may be notified to the cabin crew by a corresponding notification.

In at least some embodiments, the cabin backbone system 110 may be configured to access the respective device-owned resources 132 via an encapsulated application program at least partially run on the at least one passenger-owned device 130. The application program may be configured to restrict data access from the respective passenger-owned device 130 to the cabin backbone system 110 and from the cabin backbone system 110 to the respective passenger-owned device 130.

In at least some embodiments, the cabin backbone system 110 may be configured to receive authorization information from the at least one passenger-owned device 130. The authorization information may indicate whether the respective passenger-owned device 130 allows its second computing power to be utilized by the cabin backbone system 110.

FIG. 2 illustrates an exemplary passenger-owned device 130. In at least some embodiments, the cabin backbone system 110 may be configured to provide a prompt 134, e.g., user prompt, to the at least one passenger-owned device 130. The prompt 134 may be configured to receive indication of a respective amount of the device-owned resources 132 and/or of the second computing power to be made available to the resource pool 114.

For example, the prompt 134 may be provided via an application program at least partially run on the at least one passenger-owned device 130. The application program may be the same as the above-mentioned encapsulated application program and is in FIG. 2 indicated by the dashed rectangle. By way of example, the prompt 134 may ask the respective passenger, i.e., owner of the respective passenger-owned device 130 to “indicate the amount of device-owned resources to be shared”, i.e., to be made available to the resource pool 114, wherein the text of the prompt 134 is merely exemplary and not limited herein. In at least some embodiments, the prompt 134 may include a slider or the like configured to input the respective amount of device-owned resources 132 to be shared with the cabin backbone system 110. As mentioned above, the application program may be configured to restrict access, e.g., data access, by the at least one passenger-owned device 130 to the cabin backbone system 110 and/or vice versa.

In at least some embodiments, the passenger-owned device 130 may be configured to provide authorization information. The authorization information indicates whether the respective passenger-owned device 130 allows its second computing power to be used. According to FIG. 2, the input in response to the prompt 134 may be used for authorization, wherein this is merely one example and the authorization information may be provided in another way.

In at least some embodiments, the cabin backbone system 110 may be configured to offer at least one incentive to the at least one passenger-owned device 130 for providing its device-owned resources 132. Examples of the at least one incentive may include offering free charging of the at least one passenger-owned device, bonus miles, or any other incentive in exchange for getting access to the device-owned resource, i.e., the respective second computing power. This may also be offered, for example, if the respective passenger is not interested in access to e.g., enhanced IFE functions, or the like.

FIG. 3 illustrates an exemplary aircraft 200. The aircraft 200 comprises the computing system 100 as disclosed herein.

Further, in at least some embodiments, the aircraft 200 may comprise at least one detection device 210 configured to capture at least part of a cabin of the aircraft 200. For example, the at least one detection device 210 may comprise at least one of a cabin video monitoring system (CVMS) video feed and at least one other cabin sensor. Data captured by the at least one detection device 210 may be fed into the cabin backbone system 110 for further processing. For this, the resource pool 114 may be utilized.

FIG. 4 illustrates in a flow chart an exemplary method 300 for providing computing power in an on-board computing system, e.g., the above computing system 100, for an aircraft, e.g. the above aircraft 200.

The method 300 comprises providing 310, by a cabin backbone system comprising system-owned resources 112, first computing power. The method 300 further comprises connecting 320, via at least one device interface, at least one passenger-owned device, comprising device-owned resources configured to provide second computing power, to the cabin backbone system. Further, the method comprises controlling 330, by the cabin backbone system, utilization of the second computing power provided via the at least one device interface to form a resource pool controlled by the cabin backbone system to enhance the first computing power of the cabin backbone system.

It is noted that the method 300 may be further configured in accordance with the embodiments disclosed herein, especially according to the embodiments described for the above computing system 100.

The above-described aspects, embodiments, variants and examples can of course be combined without this being explicitly described. Each of the described variants and each example are thus to be regarded as optional for each of the aspects, embodiments, variants and examples or even combinations thereof. The present disclosure is thus not limited to the individual embodiments and variants in the described order or a certain combination of the aspects and variants.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 computing system
110 cabin backbone system
112 system-owned resource(s)
114 resource pool
120 device interface
130 passenger-owned device
132 device-owned resource(s)
134 prompt
200 aircraft
210 detection device
300 method
3xx method step(s)

1. An on-board computing system for an aircraft, comprising:
a cabin backbone system comprising system-owned resources configured to provide first computing power; and
at least one device interface configured to connect at least one passenger-owned device comprising device-owned resources configured to provide second computing power to the cabin backbone system;
wherein the cabin backbone system is configured to control utilization of the second computing power provided via the at least one device interface to form a resource pool controlled by the cabin backbone system to enhance the first computing power of the cabin backbone system.

2. The on-board computing system of claim 1, wherein the cabin backbone system is configured to combine the first computing power and the second computing power to provide at least one service, or function, or both in addition to a basic service, or a basic function, or both that are only configured to be provided with the first computing power.

3. The on-board computing system of claim 1, wherein the resource pool comprising the first computing power and the second computing power is used by the cabin backbone system to operate at least one artificial intelligence-based application configured to analyze cabin data received from at least one detection device configured to capture at least part of a cabin of the aircraft.

4. The on-board computing system of claim 3, wherein the at least one artificial intelligence-based application is configured to analyze, based on a received cabin data, a passenger-related issue, an equipment-related issue, or both, and to report at least one issue based on the analyzing.

5. The on-board computing system of claim 1, wherein the cabin backbone system is configured to access the device-owned resources via an encapsulated application program at least partially run on the at least one passenger-owned device, the encapsulated application program configured to restrict data access from the at least one passenger-owned device to the cabin backbone system, or from the cabin backbone system to the at least one passenger-owned device, or both.

6. The on-board computing system of claim 1, wherein the cabin backbone system is configured to receive authorization information from the at least one passenger-owned device, the authorization information indicating whether the at least one passenger-owned device allows the second computing power to be utilized.

7. The on-board computing system of claim 1, wherein the cabin backbone system is configured to provide a prompt to the at least one passenger-owned device, the prompt configured to receive indication of an amount of the device-owned resources, or the second computing power, or both to be made available to the resource pool.

8. The on-board computing system of claim 1, wherein the cabin backbone system is configured to offer at least one incentive to the at least one passenger-owned device for providing the device-owned resources.

9. An aircraft comprising:
the on-board computing system according to claim 1.

10. A method for providing computing power in an on-board computing system for an aircraft, the method comprising:
providing, by a cabin backbone system comprising system-owned resources, a first computing power;
connecting, via at least one device interface, at least one passenger-owned device, comprising device-owned resources configured to provide a second computing power to the cabin backbone system; and
controlling, by the cabin backbone system, utilization of the second computing power provided via the at least one device interface to form a resource pool controlled by the cabin backbone system to enhance the first computing power of the cabin backbone system.
